(19) United States
(12) Patent Application Publication
(10) Pub. No.: US 2026/0237234 A1
(43) Pub. Date: Aug. 13, 2026

(54) GAZE PREDICTOR

(71) Applicant: PwC Product Sales LLC, New York, NY (US)

(72) Inventors: Shaz HODA, New York, NY (US); John Rea SWADENER, Fort Lauderdale, FL (US); Louis James BENNETT, New York, NY (US); Pasquale GARGIULO, Plantation, FL (US); Benjamin FORD, Coral Springs, FL (US); Kimberly CLIFFORD, Lincolnwood, IL (US); Siddhesh Shivaji ZANJ, Mumbai (IN); Amit AGGARWAL, New Delhi (IN); Yang LIN, Shanghai (CN)

(73) Assignee: PwC Product Sales LLC, New York, NY (US)

(21) Appl. No.: 17/608,408

(22) PCT Filed: Jul. 30, 2021
(86) PCT No.: PCT/CN2021/109554

§ 371 Date: Nov. 2, 2021

(51) Int. Cl. G06V 30/414; G06T 11/20; G06V 10/774

(52) U.S. Cl. CPC G06V 30/414; G06T 11/26; G06V 10/774

(57) ABSTRACT

Embodiments in accordance with this disclosure provide a system and method for predicting an attention level of a viewer corresponding to one or more portions of a media item. The method can include receiving a media item, segmenting the media item into one or more segments, each segment corresponding to a portion of the media item, identifying one or more characteristics associated with each segment of the one or more segments, providing the segmented media item and identified characteristics to a machine-learning model that has been trained using empirical data from identified user gaze locations on training media items, and generating a heat map that predicts the attention level of the viewer corresponding to the one or more segments of the digital media item based on the segmented media item, identified characteristics, and the empirical data.

### REFERENCE TO RELATED APPLICATIONS

This application is a national stage application under 35 USC 371 of International Application No. PCT/CN 2021/109554, filed Jul. 30, 2021, the entire contents of which are incorporated herein by reference.

### FIELD

This disclosure relates in general to systems for predicting an attention level of a user with respect to one or more portions of a displayed media item, and in particular to training a machine-learning model for predicting an attention level of a user with respect to one or more portions of a displayed media item.

### BACKGROUND

The attention span of the average human has been on a decline from about 12 seconds in 2000 to about 8 seconds in 2013. Thus, goldfish, which have an average attention span of about 9 seconds, have longer attention spans than the average human today. Accordingly, content creators who design media items, such as websites, presentations, documents, graphical user interfaces (GUIs) and the like, should endeavor to capture and focus the attention of a viewer long enough to convey an intended message. This is particularly important in digital media where many different digital media items and/or applications can potentially be vying for a user's attention.

One way to determine whether a viewer's attention will be optimized, e.g., steered to desired parts of a media item, is to test and evaluate the layout of the media item. Generally, content creators can evaluate the layout of a media item by testing where a user focuses their attention on digitally displayed media. For example, content creators can present the layout to a human subject who can then manually provide feedback via click activity or eye movement tracking. For example, if a subject clicks on an icon or link on the displayed digital media, this behavior can indicate that the subject's attention was focused on the corresponding icon or link. Similarly, sensors, e.g., eye-tracking sensors, can be used to measure a location of the subject's gaze on the displayed layout. Based on the click activity or gaze location, the content creator can determine whether the current layout of the digital media is effective.

One drawback to current techniques is that one or more human subjects are necessary to manually provide feedback (e.g., by monitoring click through rate and/or gaze location) to evaluate each layout. Obtaining manual feedback from subjects can quickly become a cumbersome and expensive process, particularly if the content creator is testing and iterating on multiple layouts of the digital media item based on the provided feedback. Accordingly, what is needed is a system that can test multiple different layouts of displayed digital media without relying on test subjects to view and provide feedback on each layout.

### BRIEF SUMMARY

Embodiments of the present disclosure can include a system and method to predict an attention level of a viewer corresponding to one or more portions of a media item. The method can include receiving a media item, segmenting the media item into one or more segments, each segment corresponding to a portion of the media item, identifying one or more characteristics associated with each segment of the one or more segments, providing the segmented media item and identified characteristics to a machine-learning model that has been trained using empirical data from identified user gaze locations on training media items, and generating a heat map that predicts the attention level of the viewer corresponding to the one or more segments of the digital media item based on the segmented media item, identified characteristics, and the empirical data.

Embodiments of the present disclosure can include a system and method predict attention level of a viewer corresponding to one or more portions of a digital media item. The method can include displaying, to a subject, a training media item on a display, wherein the training media item can include one or more segments corresponding to a portion of the displayed training media item and each segment can include one or more identifying characteristics, receiving, from one or more sensors, eye-tracking information corresponding to a gaze location of the subject on the displayed training media item, determining an eye-tracking score for each of the one or more segments of the training media item based on the eye-tracking data, and training, based on the identified one or more characteristics associated with each segment of the one or more segments and the determined eye-tracking score for each of the one or more segments, a machine-learning model configured to receive an input media item and predict the attention level of a viewer corresponding to the one or more segments of the input media item.

Embodiments of the present disclosure can include a system that can predict an attention level of a viewer corresponding to one or more portions of a media item. The system can include a display, one or more processors, a memory, and one or more programs, wherein the one or more programs can be stored in the memory and configured to be executed by the one or more processors, the one or more programs including instructions for receiving the media item, segmenting the media item into one or more segments, each segment corresponding to a portion of the media item, identifying one or more characteristics associated with each segment of the one or more segments, providing the segmented media item and identified characteristics to a machine-learning model that can be trained using empirical data from identified user gaze locations on training media items, and generating a heat map that can predict the attention level of the viewer corresponding to the one or more segments of the digital media item based on the segmented media item, identified characteristics, and the empirical data

### BRIEF DESCRIPTION OF THE DRAWINGS

The invention will now be described, by way of example only, with reference to the accompanying drawings, in which:

FIGS. 1A-1C illustrate exemplary processes for training a machine-learning model, according to one or more embodiments of the disclosure.

FIG. 2 illustrates an exemplary media item, according to one or more embodiments of the disclosure.

FIG. 3 illustrates an exemplary media item, according to one or more embodiments of the disclosure.

FIG. 4 illustrates exemplary eye-tracking information, according to one or more embodiments of the disclosure.

FIG. 5 illustrates an exemplary process for predicting a viewer's attention level, according to one or more embodiments of the disclosure.

FIG. 6 illustrates an exemplary heat map, according to one or more embodiments of the disclosure.

FIGS. 7A-7B illustrate exemplary heat maps, according to one or more embodiments of the disclosure.

FIGS. 8A-8B illustrate exemplary heat maps, according to one or more embodiments of the disclosure.

FIGS. 9A-9B illustrate exemplary heat maps, according to one or more embodiments of the disclosure.

FIGS. 10A-10B illustrate exemplary heat maps, according to one or more embodiments of the disclosure.

FIGS. 11A-11B illustrate graphs showing the accuracy of the gaze predictions, according to one or more embodiments of the disclosure.

FIGS. 11C-11D illustrate exemplary heat maps, according to one or more embodiments of the disclosure.

FIGS. 12A-12D illustrate an exemplary graphical user interface, according to one or more embodiments of the disclosure.

FIG. 13 illustrates an example functional block diagram for an exemplary system, according to one or more embodiments of the disclosure.

### DETAILED DESCRIPTION

Described herein are systems and methods for predicting an attention level of a viewer with respect to one or more portions of a digital media item. In one or more examples, a method for predicting an attention level of a viewer with respect to one or more portions of a media item can include receiving the media item. The method can further include segmenting the media item into one or more segments, each segment corresponding to a portion of the displayed media item. Based on the segmented media item, one or more characteristics associated with each segment of the one or more segments can be identified. The segmented media item and identified characteristics can then be provided to a machine-learning model that has been trained using empirical data from identified user gaze locations on training media items. Based on the segmented media item, identified characteristics, and the empirical data a heat map that predicts an attention level of a viewer with respect to one or more portions of the digital media item can be generated.

Described herein are systems and methods for training a machine-learning model to predict an attention level of a viewer with respect to one or more portions of a digital media item.

Embodiments of the present disclosure can display, to a subject, a training media item on a display, where the training media item can include one or more segments corresponding to a portion of the training media item and each segment can include one or more identifying characteristics.

Embodiments of the present disclosure can receive, from one or more sensors, eye-tracking information corresponding to a gaze location of the subject on the training media item and determine an eye-tracking score for each of the one or more segments of the training media item based on the eye-tracking data. Embodiments of the present disclosure can train, based on the identified one or more characteristics associated with each segment of the one or more segments and the determined eye-tracking score for each of the one or more segments, a machine-learning model configured to receive an input media item and predict an attention level of a viewer with respect to one or more portions of the input media item.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The methods, devices, and systems described herein are not inherently related to any particular computer or other apparatus. To the extent that specific devices, apparatuses are described as including one or more modules and/or algorithms described with respect to one or more examples of this disclosure, the architecture of the methods, devices, and systems described herein are not limited to these specific configurations. For example, various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Due to the decreasing attention span of the average human, content creators who design media items, such as websites, presentations, documents, graphical user interfaces (GUIs) and the like, should endeavor to capture and focus the attention of a viewer long enough to convey an intended message. This is particularly important in digital media where many different digital media items and/or applications can potentially be vying for a user's attention.

One way content creators can determine whether viewer's attention will be optimized, e.g., steered to desired parts of a media item, is to test and evaluate the layout of the media item. Generally, content creators can evaluate the layout of a media item by testing where a user focuses their attention on digitally displayed media. For example, content creators can present the layout to a human subject who can then manually provide feedback via click activity or eye movement tracking. For example, if a subject clicks on an icon or link on the displayed digital media, this behavior can indicate that the subject's attention was focused on the corresponding icon or link.

Similarly, sensors, e.g., eye-tracking sensors, can be used to measure a location of the subject's gaze on the displayed layout. Based on the click activity or gaze location, the content creator can determine whether the current layout of the digital media is effective. However, obtaining manual feedback from subjects can quickly become a cumbersome and expensive process, particularly if the content creator is testing and iterating on multiple layouts of the digital media item based on the provided feedback. Accordingly, what is needed is a system that can test multiple different layouts of displayed digital media without relying on test subjects to view and provide feedback on each layout.

Embodiments of the present disclosure can predict an attention level of a viewer with respect to one or more portions of a media item. In some embodiments, systems according to this disclosure can predict a relative duration of a viewer's gaze location when viewing one or more portions of a media item. Embodiments of the present disclosure can identify one or more regions of the digital media item where the user's gaze location and attention is focused for the longest period of time. Embodiments of the present disclosure can advantageously facilitate the evaluation of a layout of a media item for content creators. In some embodiments, digital content creators can redesign the layout of the media item based on the prediction.

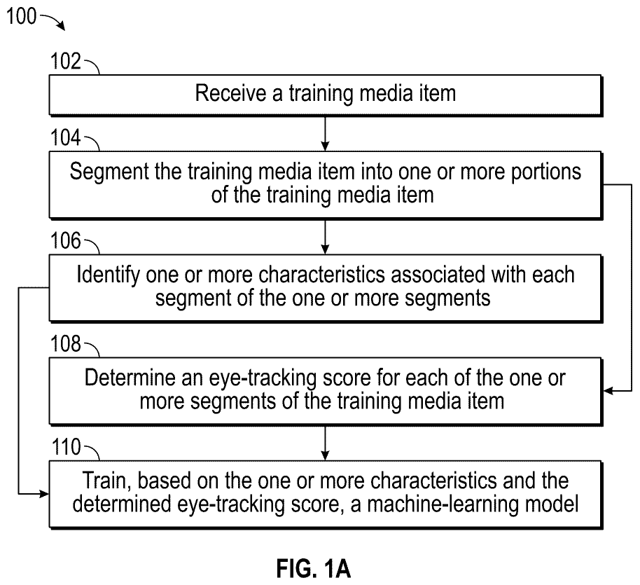

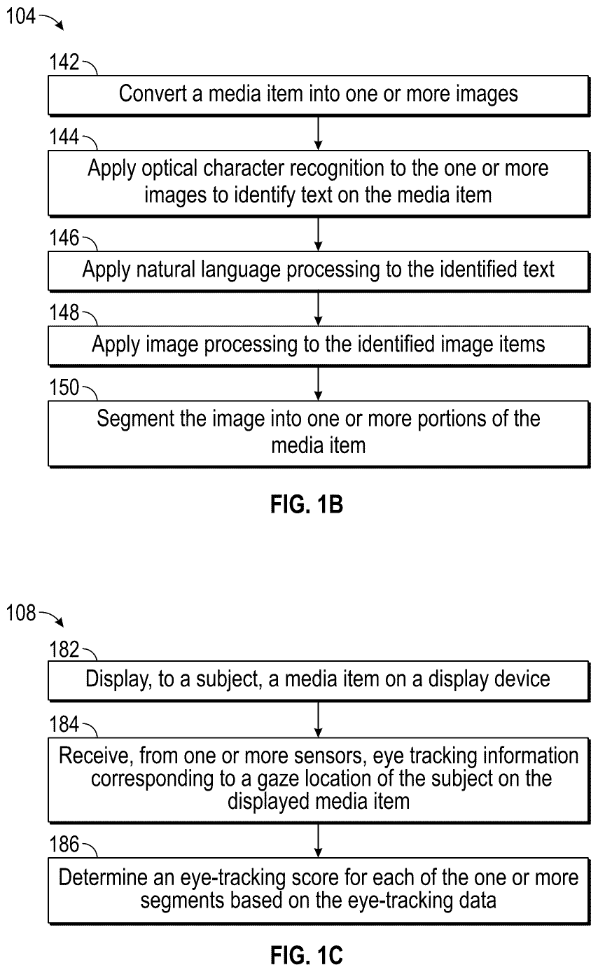

FIGS. 1A-1C illustrate an exemplary process 100 for training a machine-learning model for predicting an attention level of a viewer with respect to one or more portions of a media item, according to one or more embodiments of the disclosure. Process 100 can be performed, for example, using one or more electronic devices implementing a software platform. In some examples, process 100 can be performed using a client-server system, and the blocks of process 100 can be divided up in any manner between the server and a client device. In other examples, the blocks of process 100 can be divided up between the server and multiple client devices. Thus, while portions of process 100 are described herein as being performed by particular devices of a client-server system, it will be appreciated that process 100 is not so limited. In other examples, process 100 is performed using only a client device (e.g., personal computer) or only multiple client devices. In process 100, some blocks are, optionally, combined, the order of some blocks is, optionally, changed, and some blocks are, optionally, omitted. In some examples, additional steps may be performed in combination with the process 100. Accordingly, the operations as illustrated (and described in greater detail below) are exemplary by nature and, as such, should not be viewed as limiting.

With reference to FIG. 1A, an exemplary system can receive a training media item at step 102. For example, the training media item can be uploaded to the system via an electronic device such as a personal computer, laptop, tablet, mobile phone, and the like. The training media item can include, for example, a presentation, webpage, document, or other digital media item that can be displayed to a subject via the electronic device. In some embodiments, the training media item can be provided to the system as a pdf file. In some embodiments, the training media item can include one or more pages. A skilled artisan will understand that the type of media item is not intended to limit the disclosure.

At step 104, the training media item can be segmented into one or more portions, e.g., segments, based on the training media item. For example, each segment can correspond to a region or portion of the displayed training media item. As used herein, the term “displayed training media item” can be used to describe a media item or portion of a media item (e.g., a slide of a presentation or page of a document) as it would be displayed to a subject via a display device. In some embodiments, the segments can correspond to one or more text items, e.g., words, and/or image items. That is, the displayed training media item can be segmented based on the layout of text and images included on a respective page or slide of the media item. In some embodiments, natural language processing can be used to evaluate the text and aid in determining the segments.

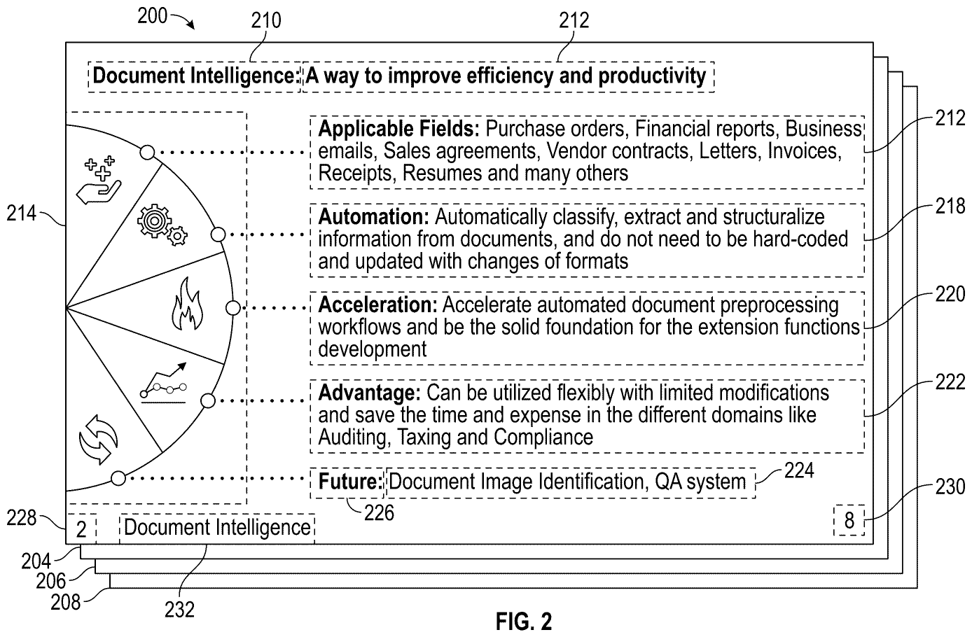

FIG. 2 illustrates an exemplary media item 200, according to one or more embodiments of the disclosure. As shown in the figure, the media item 200 can correspond to a presentation, e.g., slide deck, that one or more slides 202-208 that can be displayed to a viewer. In some embodiments, the media item can include a single page or slide. Although the media item 200 is discussed with respect to a presentation that includes one or more slides, media items can also correspond to a webpage, a document, and the like. Accordingly, the provided examples of a media item are not intended to be limiting and other displayed media items that include image items and/or text items may be used without departing from the scope of this disclosure.

As shown in the figure, slide 202 of the media item can 200 include a plurality of segments 210-234, where each segment corresponds to a portion of the displayed slide 202. For example, segments 210 and 212 correspond to the title, segment 214 corresponds to an image item, segments 216-228 correspond to the body text, segments 228-232 correspond to navigational cues. In some embodiments, the segments can correspond to a portion of the slide that includes one or more tokens, e.g., one or more image items and/or one or more text items. As used herein, a token can refer to an individual text item, e.g., word, or image item. For example, segment 210 can correspond to the rectangular region that includes two tokens, e.g., the words “Document Intelligence:”. As another example, segment 214 can correspond to a single token, e.g., the region bounding the image item 234. As another example, segment 232 can correspond to a single token, e.g., the region bounding “2.” In some embodiments a token can include both text and an image. For example, in some embodiments, an image item can include text.

An exemplary process for segmenting a media item (e.g., step 104) is described in greater detail with respect to FIG. 1B. At step 142, the media item can be converted to one or more images. For example, in some embodiments, the training media item can be converted to an image file format, e.g., JPEG, TIFF, GIF, BMP, PNG, and the like. In some examples, a media item may include multiple pages or slides. In such examples, each page or slide can be converted to an image. For example, the media item 200 includes one or more slides 202-208. Accordingly, in some embodiments, each slide 202-208 can be converted into a respective image. Each image may correspond to how each slide of the media item would be displayed to a viewer. In some examples, the media item can be converted into a single image. For example, the media item 200 could be converted into an image with all the slides stitched together to form a single image.

At step 144, the system can apply optical character recognition to the one or more images. The optical character recognition can be used to identify text included in the one or more images and convert the identified text into a machine-readable format. For example, optical character recognition can be applied to slide 202 to convert the text into a machine-readable format. For example, optical character recognition can be used to identify the text “Document Intelligence: A way to improve efficiency and productivity” and convert the text into a machine-readable format, for example, but not limited to a text stream, file of characters (e.g., CSV), and the like.

At step 146, the system can apply one or more computer vision techniques to identify image items on the image. For example, referring to slide 202, computer vision techniques can be applied to recognize image item 234. At step 148, the system can segment the image into one or more portions, e.g., segments, based on the identified text and the identified image item. In some embodiments, each segment can include one or more tokens, e.g., word items and image items. In some embodiments, the segments can be based on a distance between the tokens. For example, the distance between the tokens can be used to determine whether to group one or more tokens into a segment. Slide 202 illustrates an exemplary media item that has been segmented according to embodiments of the disclosure, where the dashed lines indicate the segment 210-234.

In some embodiments, a machine-leaning model can be used to segment the image. For example, the image, and each token (including the position data associated with each token) can be input into a segmenting model. The segmenting model can segment the image and output the segments corresponding to the image, e.g., location and positional information associated with each segment. The segment can include single token or a collection of tokens, depending on the size and placement of the image. The segmenting model can be implemented using, for example, OpenCV, OCR (torch, tensorflow/keras, tesseract), Sklearn, CRAFT, RefineNet, and the like.

Although an exemplary process for segmenting a media data is described with respect to FIG. 1B, this method is exemplary and some steps can be, optionally, combined, the order of some blocks can be, optionally, changed, and some blocks can be, optionally, omitted. In some examples, additional steps may be performed in combination with the process associated with step 104. Accordingly, the operations as illustrated are exemplary by nature and, as such, should not be viewed as limiting.

Turning to FIG. 1A, once the training media item has been segmented, the system can identify one or more characteristics associated with each segment of the one or more segments at step 106. For example, the system can apply computer vision techniques and natural language processing to identify and associate one or more visual characteristics with each segment. The one or more visual characteristics may correspond to aspects of the displayed media item that could catch a viewer's gaze. In some embodiments the one or more characteristics can include at least one selected from text location (e.g., text coordinates), segment location (e.g., segment coordinates), size rate between text and segment, text size, segment size, center coordinates of text, capital letter, non-alpha characters, number of characters, a token term-frequency inverse document frequency (Tf-Idf), and color. As used herein, the Tf-Idf can refer to a metric used as an indicator to evaluate the importance of a token, e.g., word, to a media item and/or collection of media items. For example, a word that is used frequently in a target document and is not used frequently in other documents can have a high degree of uniqueness or importance to the target document and hence a high Tf-Idf weight. Conversely, a term such as ‘and’ which occurs across all slides, and/or all documents may have a low Tf-Idf. In some examples, terms that occur frequently across a few slides but not in all slides can have a high Tf-Idf score. In some examples, words that are rarely used can have a medium to low Tf-Idf.

At step 108, the system can determine an eye-tracking score for each of the one or more segments of the training media item. In some embodiments, the eye-tracking score can indicate an amount of time a viewer looks at a particular region of a displayed media item. In some embodiments, the eye-tracking score can be associated with a gaze path of the viewer on the displayed media item. For example, the gaze path can be indicative of the path of the user's gaze as the viewer looks at the displayed media item. The eye-tracking score can be determined based on empirical data collected from sensors that can track the gaze of human test subjects looking at the displayed media item. The process of determining an eye-tracking score is described in greater detail with respect to FIG. 1C, below.

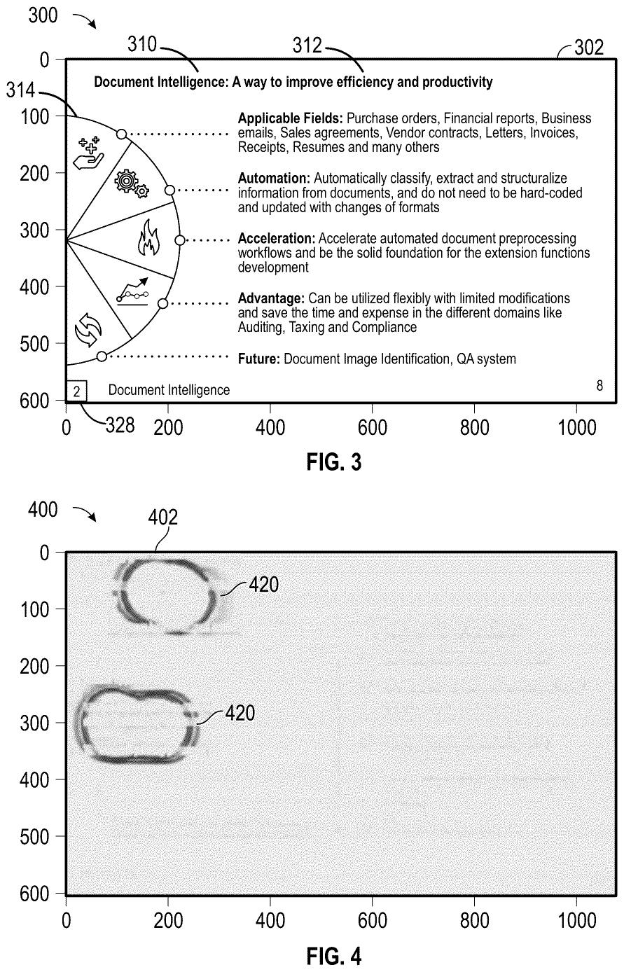

FIG. 1C illustrates an exemplary process for determining an eye-tracking score for each of the one or more segments of the segmented media item (e.g., step 108). At step 182, the system can display a training media item to a subject via a display device. FIG. 3 illustrates an exemplary training media item 300 in accordance with embodiments of the current disclosure. Training media item 300 can include one or more slides, e.g., slide 302. For example, slide 302 can be displayed to the subject. The displayed training media item, e.g., slide 302, can include one or more segments, e.g., segments 310-332. The training media item can be displayed on, for example, a personal computer with a display. In some embodiments, the system can include a monitor, television, laptop, tablet, mobile device with a display, and the like. In some embodiments, the display device can include a piece of paper or other printed media. Accordingly, the type of display is not intended to limit the scope of this disclosure.

At step 184, the system can receive from one or more sensors, eye-tracking information corresponding to a gaze location of the subject on the displayed training media item. FIG. 4 illustrates an exemplary eye-tracking information corresponding to a gaze location of the subject. In some embodiments, as shown in the figure, the eye-tracking information can include one or more eye-tracking bubbles 420. The eye-tracking bubbles can indicates a gaze location of the subject as the subject views the slide 402. In some embodiments, a centroid of the eye-bubble can be used as a location of the user's gaze location.

In some embodiments, the eye-tracking information can correspond to a video. In some embodiments, each frame of the video can include one or more eye-tracking bubbles. For example, slide 402 can correspond to a frame of such a video. Accordingly, the video can be used to determine a location of a subject's gaze through time. In this manner, a duration that the gaze of the subject is focused on a particular region of the slide 402 can be determined based on empirical data obtained from the one or more sensors. In some embodiments, a gaze path of the user can also be determined.

In some embodiments, the one or more sensors can correspond to an eye-tracking system. Some exemplary eye-tracking systems include Tobii, GazeCloudAPI, SensoMotoric Instruments, EyeLink, and Smart Eye. In some embodiments, the display device can include one or more eye-tracking sensors. For example, the display device can correspond to a virtual reality system that can both display the training media item and track a subject's gaze location. These eye-tracking systems are merely exemplary and are not intended to limit the scope of this disclosure.

At step 186, the system can determine an eye-tracking score for each of the one or more segments of the training media item based on the eye-tracking data. In some embodiments, the eye-tracking score can be indicative of an amount of a time a subject's gaze location is focused on a particular segment. For example, while the subject views the training media item, e.g., slide 302, the gaze of the subject may move across the slide 302. For instance, the subject may look at the segment 310, for a first amount of time, then look at segment 312 for a second amount of time, then look at segment 314 for a third amount of time, etc. In some embodiments, each segment can have a corresponding eye-tracking score based on the amount of time the subject gazes at the subject. Thus, if the first amount of time is greater than the second amount of time, segment 310 may have a higher eye-tracking score than segment 312. If the first amount of time is the same as the second amount of time, segment 310 and segment 312 may have equivocal eye-tracking scores. If the first amount of time is less than the second amount of time, segment 310 may have a lower eye-tracking score than segment 312. In some examples, a subject may not notice a segment, that is, the gaze location of the subject may not focus on a region of the slide corresponding to the segment. For example, a subject viewing slide 302 may not notice the page number on the slide corresponding to segment 328. In such examples, the eye-tracking score for segment 328 may be negligible or otherwise indicate that the gaze of the subject did not focus on segment 328.

In some embodiments, the eye-tracking score can be indicative of an amount of a time a subject's gaze location is focused on a particular segment and/or a gaze path of the user. For example, while the subject views the training media item, e.g., slide 202, the gaze of the subject may move across the slide 202, such that the subject may look at the segment 210, for a first amount of time, then look at segment 212 for a second amount of time, and next look at segment 214 for a third amount of time, etc. In some embodiments, the gaze path can be used to provide a relative weight to the amount of time the user focused on a particular segment. For example, the first segment and/or the last segment of the gaze path of the subject may have a greater weight than segments that are viewed in the middle of the gaze path. In some embodiments, the first two or the first three viewed segments may have a greater weight. In this manner, eye-tracking score can be indicative of an amount of a time a subject's gaze location is focused on a particular segment and a gaze path of the user. A skilled artisan will understand that the eye-tracking score can be determined in a number of ways and that the specific process for determining the eye-tracking score is not intended to limit the scope of this disclosure. In some embodiments, a heat map can be generated using the eye-tracking score and corresponding segmented training media item.

Although an exemplary process for determining an eye-tracking score is described with respect to FIG. 1C, this method is exemplary and some steps can be, optionally, combined, the order of some blocks can be, optionally, changed, and some blocks can be, optionally, omitted. In some examples, additional steps may be performed in combination with the process associated with step 108. Accordingly, the operations as illustrated are exemplary by nature and, as such, should not be viewed as limiting.

Referring back to FIG. 1, at step 110, the system can train a machine-learning model, based on the one or more characteristics and the determined eye-tracking score. For example, the system can provide the segmented media item, the corresponding one or more identified characteristics, and corresponding eye-tracking score to the machine-learning model. The one or more identified characteristics and corresponding eye-tracking score can be used as groundtruth for the machine learning model. The machine-learning model can be trained using for example, a random forest model and/or a deep learning model. In some embodiments, other machine-learning methods can be applied, for example, XgBoost, Support Vector Machines. The machine-learning model can be implemented using, for example, OpenCV, Sklearn, Numpy, and the like.

The process illustrated in FIG. 1 can be repeated in order to train the machine-learning model based on multiple media items. For example, the system can receive a second training media item, segment the second media item into one or more segments corresponding to a portion of the second training media item, identify one or more characteristics associated with each segment of the one or more segments of the second training media item, determine an eye-tracking score for each segment of the one or more segments of the second training media item, and train the machine-learning model based on the one or more characteristics and the determined eye-tracking score. The machine-learning model can be trained with training media items any number of times. For example, a machine-learning model can be trained with one or more training media items until the machine-learning model can predict a gaze location of a viewer to a desired level of accuracy.

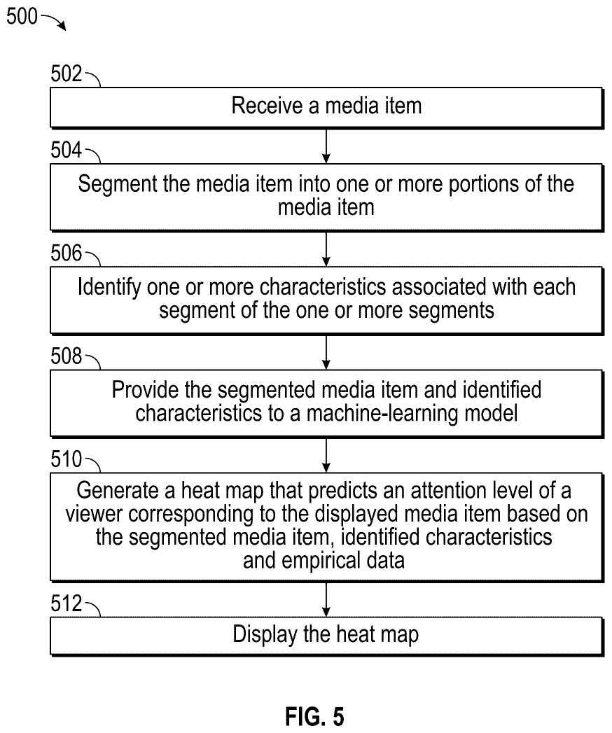

FIG. 5 illustrates an exemplary process 500 for predicting a viewer's gaze location, according to one or more embodiments of the disclosure. Process 500 can be performed, for example, using one or more electronic devices implementing a software platform. In some examples, process 500 can be performed using a client-server system, and the blocks of process 500 can be divided up in any manner between the server and a client device. In other examples, the blocks of process 500 are divided up between the server and multiple client devices. Thus, while portions of process 500 are described herein as being performed by particular devices of a client-server system, it will be appreciated that process 500 is not so limited. In other examples, process 500 is performed using only a client device (e.g., personal computer, laptop, mobile phone, and the like) or only multiple client devices. In process 500, some blocks are, optionally, combined, the order of some blocks is, optionally, changed, and some blocks are, optionally, omitted. In some examples, additional steps may be performed in combination with the process 500. Accordingly, the operations as illustrated (and described in greater detail below) are exemplary by nature and, as such, should not be viewed as limiting.

At step 502, the system can receive a media item. In some embodiments, a user can upload a media item to the system. For example, an electronic device such as a personal computer can include one or more media items, a user can select a desired media item, and upload the media item to the system. In some embodiments, the system can receive the media item via the cloud or a remote server.

At step 504, the system can segment the media item into one or more portions. For example, each segment can correspond to a region or portion of the displayed training media item. As used herein, the term “displayed media item” can be used to describe a media item or portion of a media item (e.g., a slide of a presentation or page of a document) as it would be displayed to a subject via a display device. In some embodiments, the segments can correspond to one or more text items, e.g., words, and/or image items. That is, the displayed media item can be segmented based on the layout of text and images included on a respective page or slide of the media item. In some embodiments, natural language processing can be used to evaluate the text and aid in determining the segments. In some embodiments, the system can segment the media item according to the process associated with step 104 described in FIG. 1B.

At step 506, the system can identify one or more characteristics associated with each segment of the one or more segments. For example, the system can apply computer vision techniques and natural language processing to identify and associate one or more visual characteristics with each segment. The one or more visual characteristics may correspond to aspects of the displayed media item that could catch a viewer's gaze. In some embodiments the one or more characteristics can include at least one selected from text location (e.g., text coordinates), segment location (e.g., segment coordinates), size rate between text and segment, text size, segment size, center coordinates of text, capital letter, non-alpha characters, number of characters, a token term-frequency inverse document frequency (tf-idf), and color.

At step 508, the system can provide the segmented media item and identified characteristics to a trained machine-learning model. The trained machine-learning model can be configured to receive as inputs and one or more characteristics associated with the segmented media item.

At step 510, the system can generate a heat map that predicts a location of a viewer's gaze on the media item based on the segmented media item, identified characteristics and empirical data. For example, based on the one or more characteristics and empirical data the machine-learning model can determine an attention level of a viewer with respect to each segment of the corresponding media item. In some embodiments, the attention level can correspond to a relative amount of time a viewer may look at one or more segments on the corresponding media item. To the extent that the media item includes one or more pages, a corresponding heat map can be generated for each page. In some embodiments, the attention level can be normalized on a per slide basis such that the heat map indicates the relative attention level of each of the segments on a particular slide. In some embodiments, the attention level can be normalized across the entire media item, such that the heat map indicates the relative attention level of each of the segments across the one or more pages of the media item. In some embodiments, normalizing the attention level can account for the relative size of a segment, e.g., the fact that a user may take more time to read a segment that includes more words. In some embodiments, a segment without a corresponding attention level can indicate that a subject took a cursory glance or did not gaze at the segment.

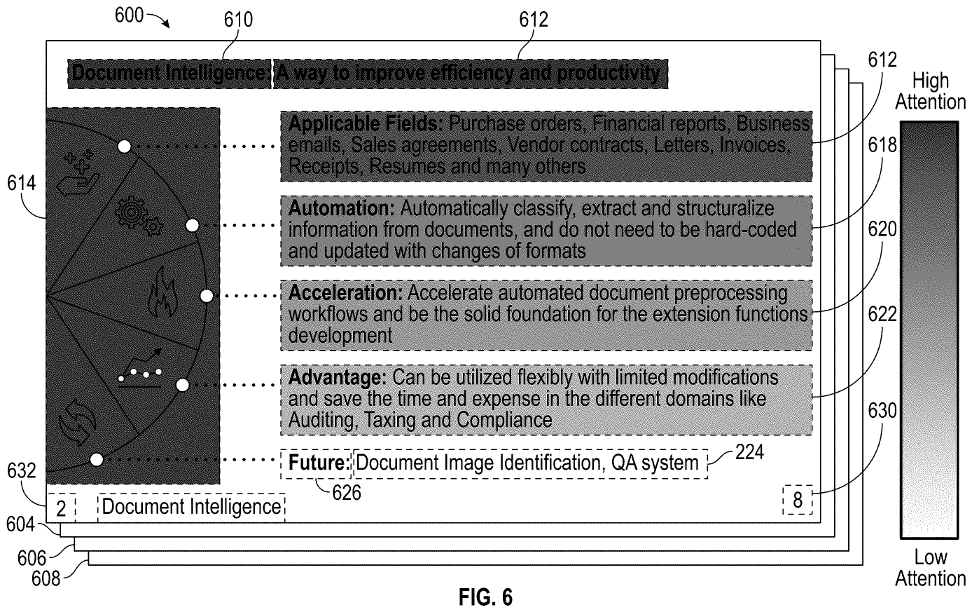

FIG. 6 illustrates an exemplary heat map 602 generated according to one or more embodiments of the disclosure. The heat map 602 can provide an indication of the amount of attention a viewer pays to each of the segments. In some embodiments, the heat map 602 can provide a color-coded indication of the amount of attention a viewer pays to each of the segments. For example, the indication can predict an attention level of a viewer with respect to each segment. In some embodiments, indication can predict a relative length of time a viewer's gaze may focus on each of the segments. As shown in heat map 602, a viewer gazing at the corresponding slide, e. g., 202, is predicted to focus a high attention on segments 610 and 612 corresponding to the title and segment 613 corresponding to the image. The viewer is predicted to focus a medium attention on segments 616-624, and a low attention on segments 626-634.

At step 512, the system can display the heat map to a user. For example, the heat map can be displayed on a user device, e.g., a personal computer, a laptop, a tablet, a mobile phone, and the like.

In some embodiments, the heat map can be used to guide a user through a process of designing and/or creating a media item. For example, if a user is creating a presentation, the user can input a first draft of the presentation into the system. As described above with respect to FIG. 5, the system can generate a first heat map based on the inputted presentation. To the extent that the presentation includes one or more pages or slides, a corresponding number of heat maps can be generated such that each heat map correspond to a slide.

Based on the results of the heat map, the user can modify one or more aspects of the presentation. For example, referring to heat map 602, if a user desires a viewer should focus a greater amount of attention on the first two bullet points of the body of the text, e.g., segments 216 and 218, the user can modify the slide accordingly. For example, the user could increase a font size of the text of segments 216 and 218, change a color of the text of segments 216 and 218, move the image to the left of the text, and the like. The user-made changes discussed are merely exemplary, and other user-made changes can be made based on a generated heat-map without departing from the scope of this disclosure. Thus, the user can generate a second draft of the presentation. The user can then input the second draft of the presentation into the system as discussed above in process 500. The system can generate and display a second heat map corresponding to the second draft presentation. The user can repeat this process of inputting a draft into the system, receiving a generated heat map, and updating the draft, to quickly iterate on presentation designs and arrive at a presentation that meets the user's design goals. In this manner, systems according to embodiments of this disclosure can be used to iterate on the design of media items in real time without requiring feedback from a human subject.

In some embodiments, the system may include a reinforcement model that can be configured to evaluate a layout for an inputted media item and/or generate a layout for an inputted media item that can optimize a user's attention. For example, the recommended layout can be designed to direct a viewer's attention to key aspects of the media item. That is, based on one or more versions of a media item, the reinforcement model can recommend a layout of the media item that can optimize a viewer's attention. In some examples, a user can input one or more media items and one or more characteristics associated with each segment of the one or more media items into the reinforcement model. In some examples, a user can also input design goals that highlight objectives that they are aiming to accomplish with the design of the media item. The reinforcement model can evaluate, e.g., provide a score, of the layout of the media item. In some embodiments, the reinforcement model can generate a recommended layout of the media item based on the one or more media items. In some embodiments, the system can apply both the machine-learning model to determine a user's attention level by generating a heat map and the reinforcement model that can recommend a layout of the media item that maximizes user attention. In some embodiments, the user can iterate on the media item layout based on one or both of the heat map and recommended layout.

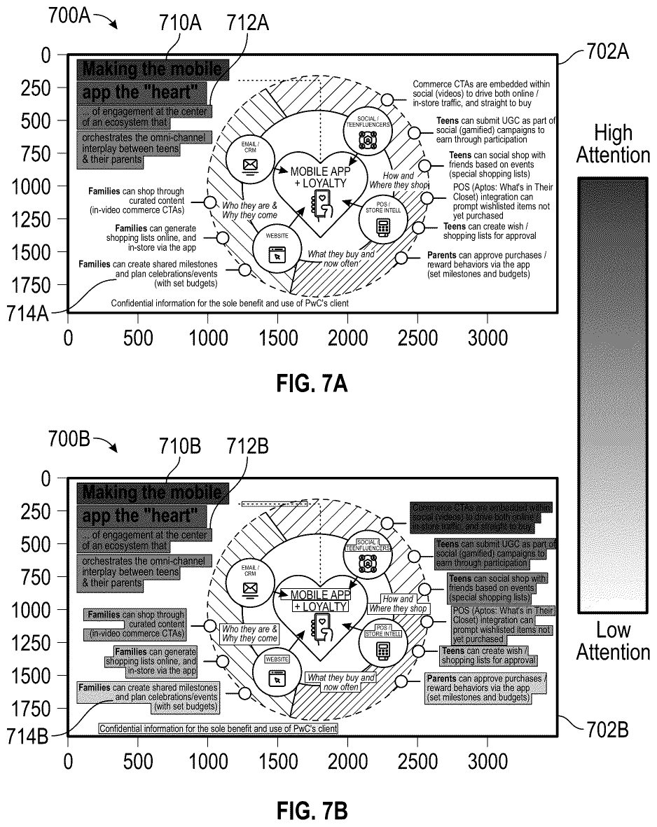

Embodiments in accordance with the present disclosure can provide an accurate and quick method to evaluate a design or layout of a media item without requiring a human individual to manually review each design or layout. FIGS. 7A-7B, 8A-8B, 9A-9B, and 10A-10B provide a comparison of a heat map generated according to embodiments of this disclosure and a heat map based on empirical eye-tracking data.

FIGS. 7A-7B illustrate exemplary eye-tracking heat maps, according to one or more embodiments of the disclosure. The heat map can provide a visual representation of a viewer's or subject's attention level with respect to one or more segments. FIG. 7A illustrates a heat map 700A corresponding to empirical eye-tracking data of a subject viewing the displayed media item 702A. For example, the heat map 700A can correspond to eye-tracking data obtained from one or more eye-tracking sensor systems, as described above with respect to FIG. 1C. FIG. 7B illustrates a heat map 700B generated based on media item 702B according to embodiments of this disclosure.

As shown in the figures, heat map 700A indicates that a subject had a high attention level, e.g., spent a relatively long amount of time gazing at segments 710A and 712A. Similarly, heat map 700B predicts that a viewer may pay a relatively high amount of attention to segment 710B and 712B. Further, heat map 700A indicates that the subject had a low attention level, e.g., spent a relatively little of time gazing at segment 714A. Similarly, heat map 700B predicts that a viewer may pay a relatively low amount of attention to segment 714B.

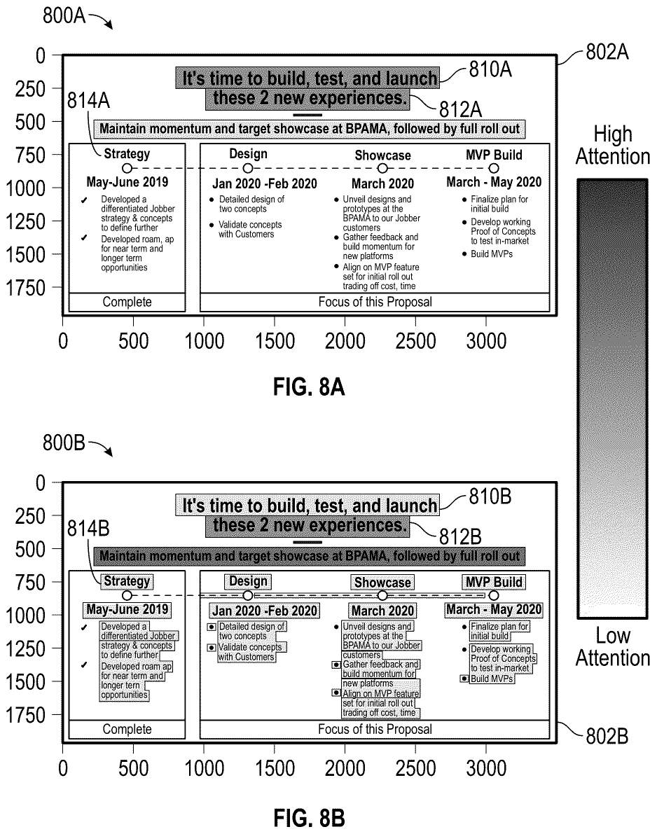

FIGS. 8A-8B illustrate exemplary eye-tracking heat maps, according to one or more embodiments of the disclosure. FIG. 8A illustrates a heat map 800A corresponding to empirical eye-tracking data of a subject viewing the displayed media item 802A. For example, the heat map 800A can correspond to eye-tracking data obtained from one or more eye-tracking sensor systems, as described above with respect to FIG. 1C. FIG. 8B illustrates a heat map 800B generated based on media item 802B according to embodiments of this disclosure.

As shown in the figures, heat map 800A indicates that a subject had a high attention level, e.g., spent a relatively long amount of time gazing at segments 810A and 812A. Meanwhile, heat map 800B predicts that a viewer may pay a relatively high amount of attention to segment 812B and less attention to 812B. Further, heat map 800A indicates that the subject had a low attention level, e.g., spent a relatively little of time gazing at segment 814A. Similarly, heat map 700B predicts that the viewer may pay a relatively low amount of attention to segment 814B.

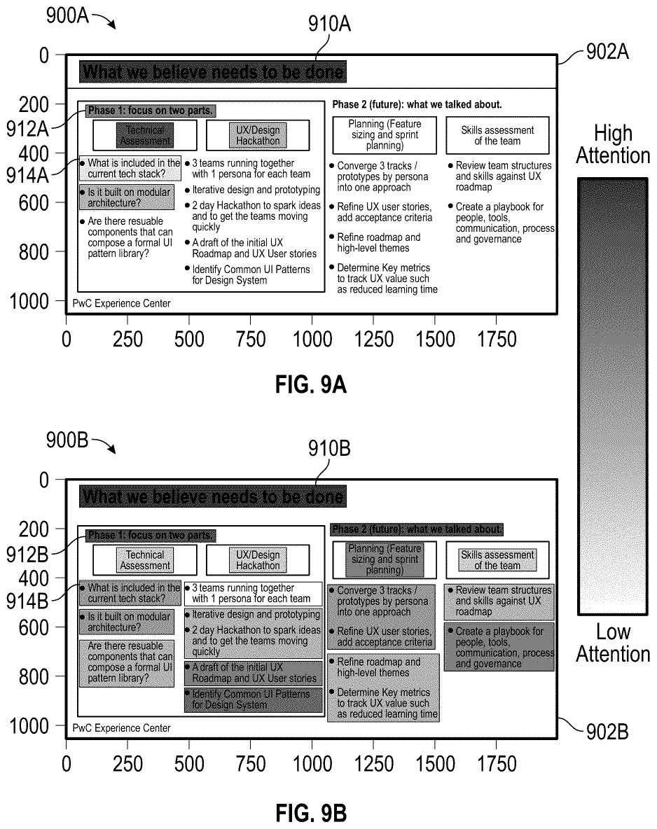

FIGS. 9A-9B illustrate exemplary eye-tracking heat maps, according to one or more embodiments of the disclosure. FIG. 9A illustrates a heat map 900A corresponding to empirical eye-tracking data of a subject viewing the displayed media item 902A. For example, the heat map 900A can correspond to eye-tracking data obtained from one or more eye-tracking sensor systems, as described above with respect to FIG. 1C. FIG. 9B illustrates a heat map 900B generated based on media item 902B according to embodiments of this disclosure.

As shown in the figures, heat map 900A indicates that a subject had a high attention level, e.g., spent a relatively long amount of time gazing at segments 910A and 912A. Similarly, heat map 900B predicts that a viewer may pay a relatively high amount of attention to segment 912B. Further, heat map 900A indicates that the subject had a medium attention level, e.g., spent a relatively moderate amount of time gazing at segment 914A. Similarly, heat map 700B predicts that the viewer may pay a relatively moderate amount of attention to segment 814B.

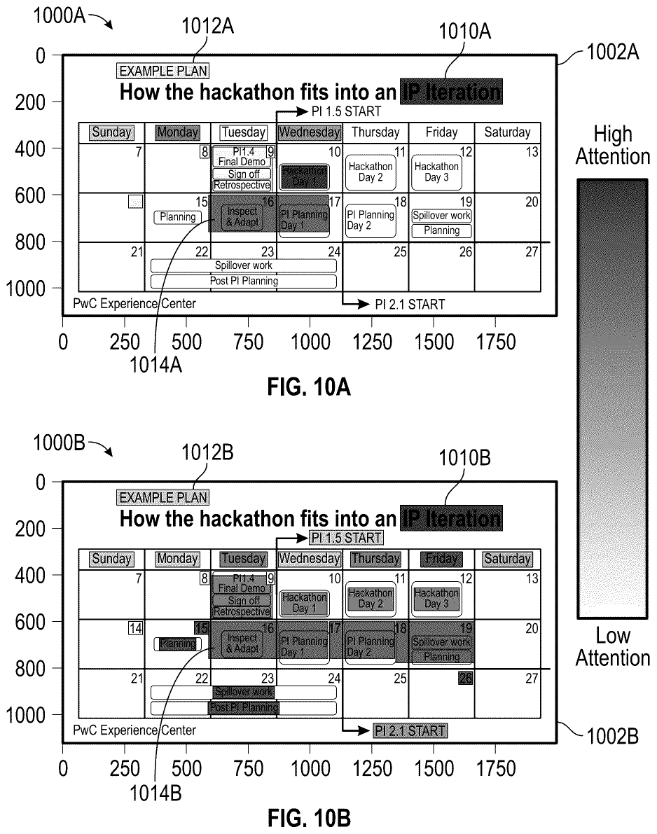

FIGS. 10A-10B illustrate exemplary eye-tracking heat maps, according to one or more embodiments of the disclosure. FIG. 10A illustrates a heat map 1000A corresponding to empirical eye-tracking data of a subject viewing the displayed media item 1002A. For example, the heat map 1000A can correspond to eye-tracking data obtained from one or more eye-tracking sensor systems, as described above with respect to FIG. 1C. FIG. 10B illustrates a heat map 1000B based on media item 1002B generated according to embodiments of this disclosure.

As shown in the figures, heat map 1000A indicates that a subject had a high attention level, e.g., spent a relatively long amount of time gazing at segment 1010A. Similarly, heat map 1000B predicts that a viewer may pay a relatively high amount of attention to segment 1010B. Further, heat map 1000A indicates that the subject had a moderate attention level, e.g., spent a moderate amount of time gazing at segment 1012A. Similarly, heat map 1000B predicts that the viewer may pay a moderate amount of attention to segment 1012B. Further, heat map 1000A indicates that the subject had a low attention level, e.g., spent a relatively little of time gazing at segment 1014A. Similarly, heat map 1000B predicts that the viewer may pay a relatively low amount of attention to segment 1014B.

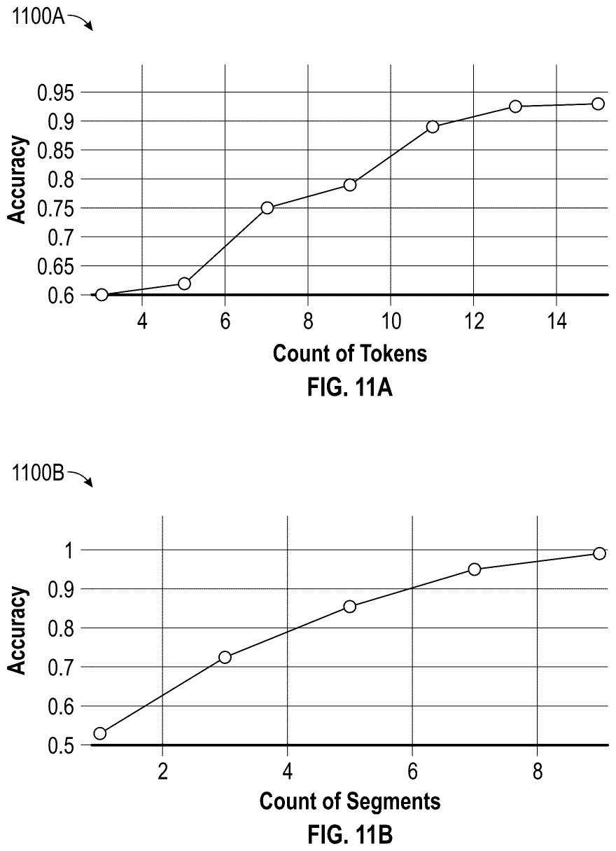

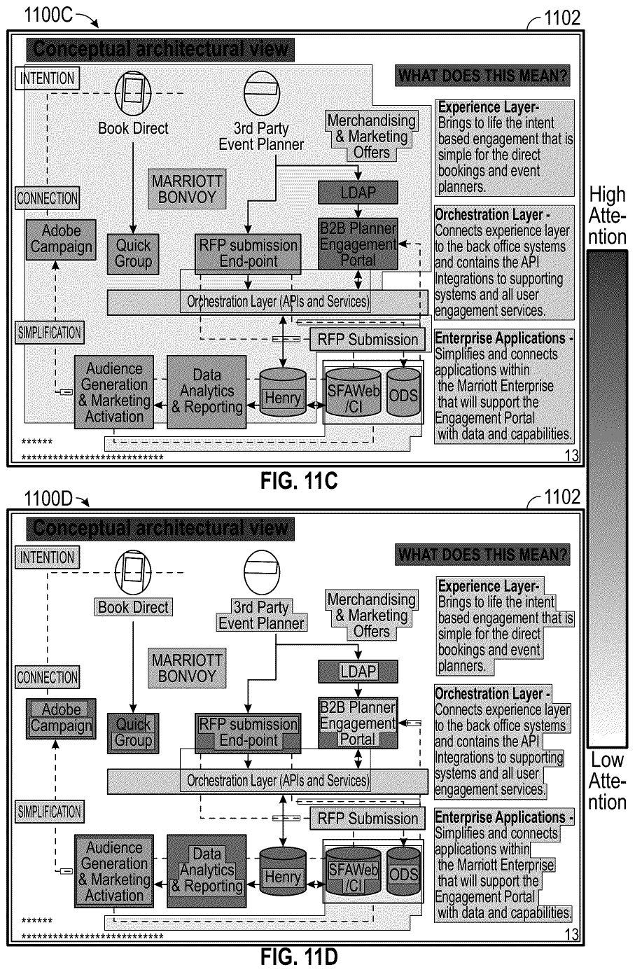

FIG. 11A illustrates a graph that demonstrates the accuracy of the machine-learning model to predict an attention level of a viewer with respect to the tokens associated with a highest attention level. In some examples, an average slide can include about 50 tokens. As shown in the graph, the machine-learning model can predict the top seven tokens, e.g., the seven tokens associated with the highest attention level with 75% accuracy. As the number of tokens increases, the accuracy can also increase. For example, the machine-learning model can predict the top fourteen tokens, e.g., the fourteen tokens associated with the highest attention level with about 92.5% accuracy. FIG. 11C illustrates a heat map 1100C corresponding to token outputs for a media item 1102. To the extent the above examples have been described with respect to segment outputs, a skilled artisan will understand that in some embodiments, each token could comprise a segment.

FIG. 11B illustrates a graph that demonstrates the accuracy of the machine-learning model to predict an attention level of a viewer with respect to the segments associated with a highest attention level. In some examples, an average slide can be include about eight segments. As shown in the graph, the system including the machine-learning model can predict the top three segments, e.g., the three segments associated with the highest attention level with about 73% accuracy. As the number of segments increases, the accuracy can also increase. For example, the machine-learning model can predict the top six segments, e.g., the six segments associated with the highest attention level, with about 90% accuracy. FIG. 11D illustrates a heat map 1100D corresponding to segment outputs for a media item 1102.

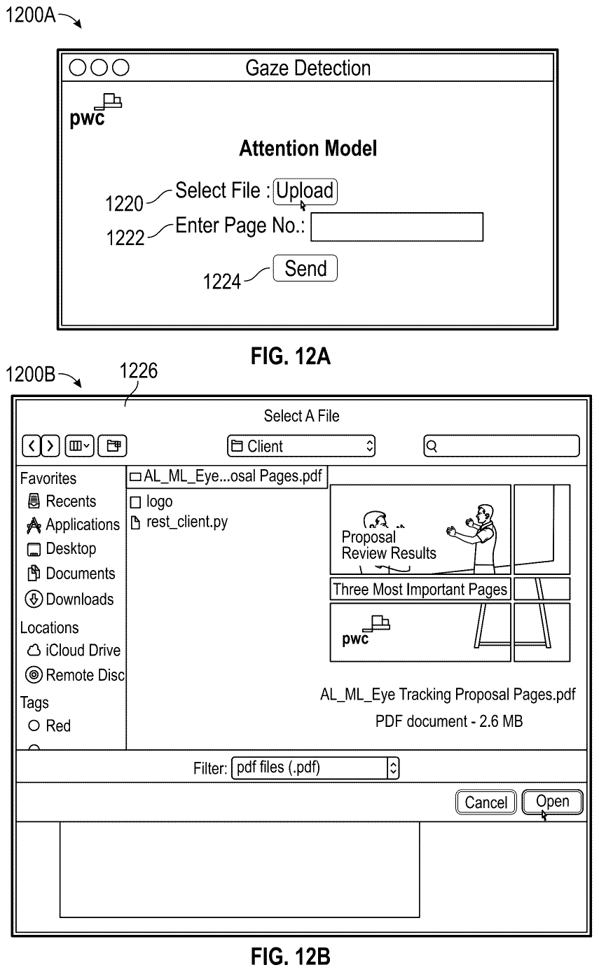

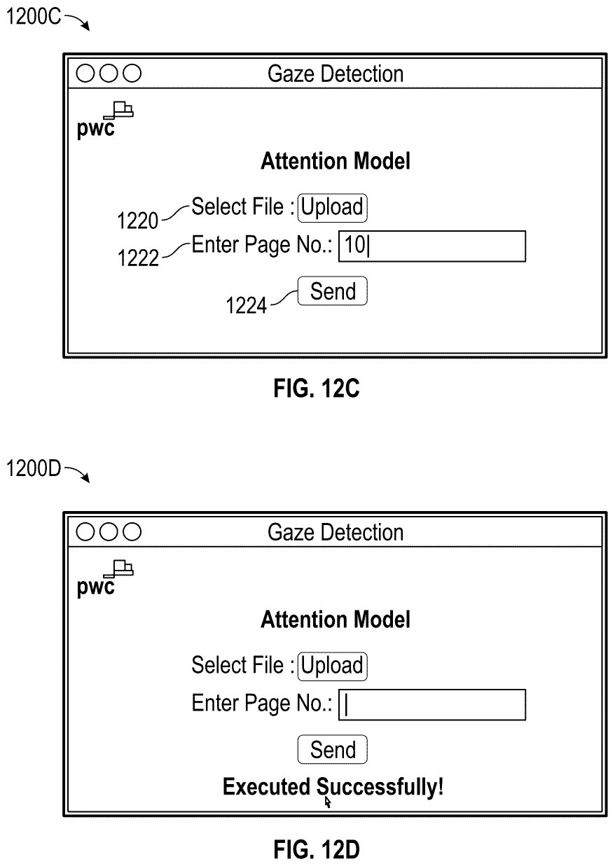

FIGS. 12A-12D illustrate an exemplary graphical user interface, according to one or more embodiments of the disclosure. FIG. 12A illustrates an exemplary graphical user interface 1200A that can be presented to a user of the system. As shown in the figure, the graphical user interface 1200A can include a control 1220 for uploading a media item, a page number field 1222, and a second control 1224 for sending a media item to a trained machine-learning model. As shown in the figure, a user can select the control 1220 to upload a media item. FIG. 12B illustrates an exemplary graphical user interface 1200B that can be presented to the user of the system. As shown in the figure, the exemplary graphical user interface 1200B can include a pop-up 1226 for a user to select a media item. In some embodiments, the media item can be selected from one or more files that reside on the electronic device displaying the graphical user interface, e.g., a personal computer, laptop, tablet, and the like. In some embodiments, the media item can be selected from one or more files that reside on a remote server.

FIG. 12C illustrates an exemplary graphical user interface 1200C that can be presented to the user of the system. As shown in the figure, once the media item is uploaded, the user can enter a number into the page number field 1222. The number can indicate a number of pages included in the media item. FIG. 12D illustrates an exemplary graphical user interface 1200D that can be presented to the user of the system. As shown in the figure, a user can select the second control 1224 for sending a media item to a trained machine-learning model. Once the media item is received via the graphical user interface, the system can process the media item to generate a heat map, as described with respect to FIG. 5. The system can then display the generated heat map, e. g., heat map 600, 700B, 800B, 900B, and/or 1000B, to the user.

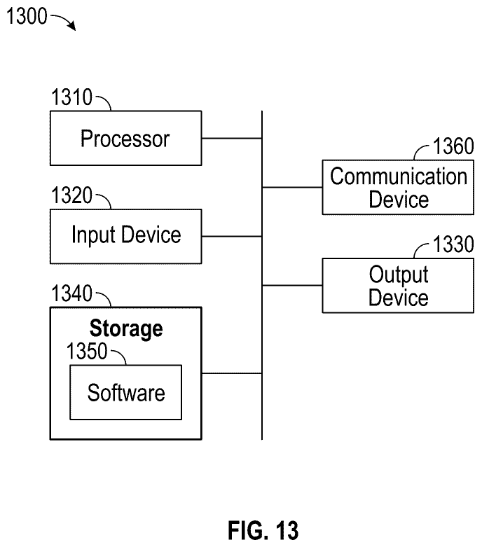

FIG. 13 illustrates an example of a computing system 1300, in accordance one or more examples of the disclosure. System 1300 can be a client or a server. As shown in FIG. 13, system 1300 can be any suitable type of processor-based system, such as a personal computer, workstation, server, handheld computing device (portable electronic device) such as a phone or tablet, or dedicated device. The system 1300 can include, for example, one or more of input device 1320, output device 1330, one or more processors 1310, storage 1340, and communication device 1360. Input device 1320 and output device 1330 can generally correspond to those described above and can either be connectable or integrated with the computer. In some embodiments the computing system can be in communication with one or more sensors, e.g., one or more eye-tracking sensors and/or eye-tracking systems, as discussed above.

Input device 1320 can be any suitable device that provides input, such as a touch screen, keyboard or keypad, mouse, gesture recognition component of a virtual/augmented reality system, or voice-recognition device. Output device 1330 can be or include any suitable device that provides output, such as a display, touch screen, haptics device, virtual/augmented reality display, or speaker.

Storage 1340 can be any suitable device that provides storage, such as an electrical, magnetic, or optical memory including a RAM, cache, hard drive, removable storage disk, or other non-transitory computer readable medium. Communication device 1360 can include any suitable device capable of transmitting and receiving signals over a network, such as a network interface chip or device. The components of the computing system 1300 can be connected in any suitable manner, such as via a physical bus or wirelessly.

Processor(s) 1310 can be any suitable processor or combination of processors, including any of, or any combination of, a central processing unit (CPU), field programmable gate array (FPGA), and application-specific integrated circuit (ASIC). Software 1350, which can be stored in storage 1340 and executed by one or more processors 1310, can include, for example, the programming that embodies the functionality or portions of the functionality of the present disclosure (e.g., as embodied in the devices as described above). For example, software 1350 can include one or more programs for performing one or more of the steps of method 100, method 104, method 108, and/or method 500.

Software 1350 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1340, that can contain or store programming for use by or in connection with an instruction execution system, apparatus, or device.

Software 1350 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 1300 may be connected to a network, which can be any suitable type of interconnected communication system. The network can implement any suitable communications protocol and can be secured by any suitable security protocol. The network can comprise network links of any suitable arrangement that can implement the transmission and reception of network signals (e.g., ethernet, wireless, or 1553) or external networks, e.g., wireless network connections, 4G, 5G, T1 or T3 lines, cable networks, DSL, telephone lines or other commercial wireless networks.

System 1300 can implement any operating system suitable for operating on the network. Software 1350 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Embodiments of the present disclosure can include a system and method for predicting an attention level of a viewer corresponding to one or more portions of a media item. The method can include receiving a media item, segmenting the media item into one or more segments, each segment corresponding to a portion of the media item, identifying one or more characteristics associated with each segment of the one or more segments, providing the segmented media item and identified characteristics to a machine-learning model that has been trained using empirical data from identified user gaze locations on training media items, and generating a heat map that predicts the attention level of the viewer corresponding to the one or more segments of the digital media item based on the segmented media item, identified characteristics, and the empirical data.

In some embodiments, the method can further include displaying the heat map. In some embodiments, the heat map can indicate a gaze of the viewer may be focused on each of the one or more segments of the media item.

In some embodiments, the one or more characteristics can include at least one selected from size, location, text size, size rate between text and segment, center coordinates of segment, color, capital letters, non-alpha characters, number of characters, and a token term-frequency inverse document frequency. In some embodiments, the media item may correspond to at least one selected from a presentation, a website, a poster, and a document. In some embodiments, each segment can include at least one selected from a text item and an image item. In some embodiments, each segment can include at least one selected from a text item and an image item.

In some embodiments, the media item can be received via a user interface, wherein the user interface can include a user interface control for uploading the media item. In some embodiments, the user interface further comprises a first field configured to receive an indication of a number of pages included in the media item.

In some embodiments, the machine-learning model can be trained by a process including displaying, to a subject, a training media item on a display, where the training media item includes one or more segments corresponding to a portion of the displayed training media item and each segment can include one or more identifying characteristics, receiving, from one or more sensors, eye-tracking information that can correspond to a gaze location of the subject on the displayed training media item, determining an eye-tracking score for each of the one or more segments of the training media item based on the eye-tracking data, and training, based on the identified one or more characteristics associated with each segment of the one or more segments and the determined eye-tracking score for each of the one or more segments, a machine-learning model configured to receive an input media item and predict the attention level of a viewer corresponding to the one or more segments of the input media item.

Embodiments of the present disclosure can include a system and method for predicting attention level of a viewer corresponding to one or more portions of a digital media item. The method can include displaying, to a subject, a training media item on a display, wherein the training media item can include one or more segments corresponding to a portion of the displayed training media item and each segment can include one or more identifying characteristics, receiving, from one or more sensors, eye-tracking information corresponding to a gaze location of the subject on the displayed training media item, determining an eye-tracking score for each of the one or more segments of the training media item based on the eye-tracking data, and training, based on the identified one or more characteristics associated with each segment of the one or more segments and the determined eye-tracking score for each of the one or more segments, a machine-learning model configured to receive an input media item and predict the attention level of a viewer corresponding to the one or more segments of the input media item.

In some embodiments, the method can further include repeating the displaying, receiving, determining, and training with a second training media item. In some embodiments, the method can further include repeating the displaying, receiving, determining, and training with a second subject. In some embodiments, the method can further include segmenting the training media item into one or more segments, each segment corresponding to a portion of the media item. In some embodiments, the method can further include identifying one or more characteristics associated with each segment of the one or more segments. In some embodiments, the eye-tracking score can be based on an amount of time the gaze location of the subject is focused on the respective segment.

In some embodiments, the system can be configured to output a heat map that can predict a location of the viewer's gaze on the displayed media item based on the eye-tracking score for each of the one or more segments and the one or more identifying characteristics for each of the one or more segments. In some embodiments, the heat map can indicate a length of time that the viewer's gaze may be focused each segment of the one or more segments. In some embodiments, the eye-tracking data can include an eye-tracking bubble, wherein the eye-tracking bubble indicates a portion of the media item corresponding to the viewer's gaze location. In some embodiments, each segment can comprise at least one selected from a word and an image. In some embodiments, the one or more characteristics can include at least one selected from size, location, text size, size rate between text and segment, center coordinates of segment, color, capital letters, non-alpha characters, number of characters, and a token term-frequency inverse document frequency. In some embodiments, the media item can correspond to at least one selected from a presentation, a website, a poster, and a document. In some embodiments, the method can further include identifying one or more characteristics of the media item by applying natural language processing to the segmented media item.

Embodiments of the present disclosure can include a system that can predict an attention level of a viewer corresponding to one or more portions of a media item. The system can include a display, one or more processors, a memory, and one or more programs, wherein the one or more programs can be stored in the memory and configured to be executed by the one or more processors, the one or more programs including instructions for receiving the media item, segmenting the media item into one or more segments, each segment corresponding to a portion of the media item, identifying one or more characteristics associated with each segment of the one or more segments, providing the segmented media item and identified characteristics to a machine-learning model that can be trained using empirical data from identified user gaze locations on training media items, and generating a heat map that can predict the attention level of the viewer corresponding to the one or more segments of the digital media item based on the segmented media item, identified characteristics, and the empirical data

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosed examples have been fully described with reference to the accompanying drawings, it is to be noted that various changes and modifications will become apparent to those skilled in the art. For example, elements and/or components illustrated in the drawings may be not be to scale and/or may be emphasized for explanatory purposes. As another example, elements of one or more implementations may be combined, deleted, modified, or supplemented to form further implementations. Other combinations and modifications are to be understood as being included within the scope of the disclosed examples as defined by the appended claims.

1. A method for predicting an attention level of a viewer corresponding to one or more portions of a media item, comprising:
receiving the media item;
segmenting the media item into one or more segments, each segment corresponding to a portion of the media item;
identifying one or more characteristics associated with each segment of the one or more segments;
providing the segmented media item and identified characteristics to a machine-learning model that has been trained using empirical data from identified user gaze locations on training media items; and
generating a heat map that predicts the attention level of the viewer corresponding to the one or more segments of the digital media item based on the segmented media item, identified characteristics, and the empirical data.

2. The method of claim 1, further comprising displaying the heat map.

3. The method of claim 1, wherein the heat map indicates a gaze of the viewer will be focused on each of the one or more segments of the media item.

4. The method of claim 1, wherein the one or more characteristics include at least one selected from size, location, text size, size rate between text and segment, center coordinates of segment, color, capital letters, non-alpha characters, number of characters, and a token term-frequency inverse document frequency.

5. The method of claim 1, wherein the media item corresponds to at least one selected from a presentation, a website, a poster, and a document.

6. The method of claim 1, wherein each segment comprises at least one selected from a text item and an image item.

7. The method of claim 1, wherein the media item is received via a user interface, wherein the user interface includes a user interface control for uploading the media item.

8. The method of claim 1, wherein the user interface further comprises a first field configured to receive an indication of a number of pages included in the media item.

9. The method of claim 1, wherein training the machine-learning model comprises:
displaying, to a subject, a training media item on a display, wherein the training media item includes one or more segments corresponding to a portion of the displayed training media item and each segment comprising one or more identifying characteristics;
receiving, from one or more sensors, eye-tracking information corresponding to a gaze location of the subject on the displayed training media item;
determining an eye-tracking score for each of the one or more segments of the training media item based on the eye-tracking data; and
training, based on the one or more identifying characteristics associated with each segment of the one or more segments and the determined eye-tracking score for each of the one or more segments, a machine-learning model configured to receive an input media item and predict the attention level of a viewer corresponding to the one or more segments of the input media item.

10. A method for training a system for predicting attention level of a viewer corresponding to one or more portions of a digital media item, comprising:
displaying, to a subject, a training media item on a display, wherein the training media item includes one or more segments corresponding to a portion of the displayed training media item and each segment comprising one or more identifying characteristics;
receiving, from one or more sensors, eye-tracking information corresponding to a gaze location of the subject on the displayed training media item;
determining an eye-tracking score for each of the one or more segments of the training media item based on the eye-tracking data; and
training, based on the identified one or more characteristics associated with each segment of the one or more segments and the determined eye-tracking score for each of the one or more segments, a machine-learning model configured to receive an input media item and predict the attention level of a viewer corresponding to the one or more segments of the input media item.

11. The method of claim 10, further comprising repeating the displaying, receiving, determining, and training with a second training media item.

12. The method of claim 10, further comprising repeating the displaying, receiving, determining, and training with a second subject.

13. The method of claim 10, further comprising segmenting the training media item into one or more segments, each segment corresponding to a portion of the media item.

14. The method of claim 10, further comprising identifying one or more characteristics associated with each segment of the one or more segments.

15. The method of claim 10, wherein the eye-tracking score is based on an amount of time the gaze location of the subject is focused on the respective segment.

16. The method of claim 10, wherein the system is configured to output a heat map that predicts a location of a gaze of the viewer's gaze on the displayed media item based on the eye-tracking score for each of the one or more segments and the one or more identifying characteristics for each of the one or more segments.

17. The method of claim 16, wherein the heat map indicates a length of time that a gaze of the viewer's will be focused on each segment of the one or more segments.

18. The method of claim 10, wherein the eye-tracking data includes an eye-tracking bubble, wherein the eye-tracking bubble indicates a portion of the media item corresponding to the subject's gaze location.

19. The method of claim 10, wherein each segment comprises at least one selected from a word and an image.

20. The method of claim 10, wherein the one or more characteristics include at least one selected from size, location, text size, size rate between text and segment, center coordinates of segment, color, capital letters, non-alpha characters, number of characters, and a token term-frequency inverse document frequency.

21. The method of claim 10, wherein the media item corresponds to at least one selected from a presentation, a website, a poster, and a document.

22. The method of claim 10, further comprising identifying one or more characteristics of the media item by applying natural language processing to the segmented media item.

23. A system for predicting an attention level of a viewer corresponding to one or more portions of a media item, comprising:
a display;
one or more processors;
a memory; and
one or more programs, wherein the one or more programs are stored in the memory and configured to be executed by the one or more processors, the one or more programs including instructions for:
receiving the media item;
segmenting the media item into one or more segments, each segment corresponding to a portion of the media item;
identifying one or more characteristics associated with each segment of the one or more segments;
providing the segmented media item and identified characteristics to a machine-learning model that has been trained using empirical data from identified user gaze locations on training media items; and
generating a heat map that predicts the attention level of the viewer corresponding to the one or more segments of the digital media item based on the segmented media item, identified characteristics, and the empirical data.
